(19) United States
(12) Patent Application Publication
(10) Pub. No.: US 2026/0100506 A1
(43) Pub. Date: Apr. 9, 2026

(54) PASSIVE REFLECTORS PROVIDING PHASE DISTRIBUTION AND METHODS OF FABRICATING THE SAME

(71) Applicant: CORNING RESEARCH & DEVELOPMENT CORPORATION, Corning, NY (US)

(72) Inventors: Viacheslav Viacheslavovich Ivanov, Espoo (FI); Aleksandr Volkov, Espoo (FI)

(21) Appl. No.: 19/416,021

(22) Filed: Dec. 11, 2025

Related U.S. Application Data
(63) Continuation of application No. PCT/US2024/031531, filed on May 30, 2024.
(60) Provisional application No. 63/523,746, filed on Jun. 28, 2023.

(51) Int. Cl. H01Q 3/46; H01Q 15/14; H01Q 15/22; H01Q 19/10

(52) U.S. Cl. CPC H01Q 3/46; H01Q 15/142; H01Q 15/22; H01Q 19/104

(57) ABSTRACT

Passive reflectors for wireless communication networks and methods of their fabrication are disclosed. In one embodiment, a passive reflector for reflecting a RF beam, the passive reflector includes a dielectric substrate. The passive reflector also includes a reflector includes an array of unit cells, where the reflector array is provided on a surface of the dielectric substrate, each unit cell includes a first conductive loop and a second conductive loop that is orthogonal to the first conductive loop, and each unit cell provides a phased distribution for two different polarizations.

### CROSS-REFERENCE TO RELATED APPLICATION

This application is a continuation of Internation Patent Application No. PCT/US2024/031531, filed on May 30, 2024, which claims the benefit of priority of U.S. Provisional Application No. 63/523,746, filed on Jun. 28, 2023, the content of which is relied upon and incorporated herein by reference in its entirety.

### BACKGROUND

Wireless communication networks used in residential and office environments utilize transmitters to propagate an RF beam (e.g., a mmWave beam) to be received by a receiver in the environment. However, the RF beam may be decimated by features of the environment, such as objects, walls, the ceiling and the floor. Further, surfaces within the environment may cause undesirable reflections resulting in the RF beam being reflected in undesirable locations, thereby leading to loss. To accommodate for such losses, network designers install additional transmitters to ensure adequate coverage. However, transmitters are costly and adding additional transmitters to the network increases the cost of installation and operation of the wireless network.

Accordingly, alternative methods and devices for optimally propagating an RF beam within an environment may be desired.

### SUMMARY

In one embodiment, a passive reflector for reflecting a RF beam, the passive reflector includes a dielectric substrate. The passive reflector also includes a reflector array that includes an array of unit cells, where the reflector array is provided on a surface of the dielectric substrate, each unit cell includes a first conductive loop and a second conductive loop that is orthogonal to the first conductive loop, and each unit cell provides a phase response for two different polarizations.

In another embodiment, a passive reflector for reflecting a RF beam, the passive reflector includes a dielectric substrate. The passive reflector also includes a reflector array that includes an array of unit cells, where the array is provided on a surface of the dielectric substrate, and the arrays of unit cells are such that the passive reflector has a total phase distribution that, for a given incident azimuth angle and a given incident elevation angle of the RF beam, provides a reflected azimuth angle and a reflected elevation angle for the RF beam that is different from one or both of the given incident azimuth angle and given incident elevation angle, provides a cylindrical phase distribution, and compensates for a wavefront sphericity of the RF beam.

In another embodiment, a wireless communication system includes a transmitter configured to emit a RF beam at an azimuth angle. The wireless communication system also includes a passive reflector for receiving the RF beam that is propagating at the azimuth and elevation angle, the passive reflector includes a dielectric substrate. The wireless communication system also includes a passive reflector for receiving the RF beam that is propagating at the azimuth and elevation angle, the passive reflector includes a reflector array includes unit cells, where the array is provided on a surface of the dielectric substrate, and the arrays of unit cells are such that the passive reflector has a total phase distribution that, for a given incident azimuth angle and a given incident elevation angle of the RF beam, provides a reflected azimuth angle and a reflected elevation angle for the RF beam that is different from one or both of the given incident azimuth angle and the given incident elevation angle, provides a cylindrical phase distribution, and compensates for a wavefront sphericity of the RF beam.

In another embodiment, a method of fabricating a passive reflector for reflecting a RF beam, the method includes determining a target receiver direction to a target receiver from the passive reflector, determining a total phase distribution that, for a given incident azimuth angle and a given elevation angle of the RF beam, provides a reflected azimuth angle for the RF beam that is aligned with the target receiver direction, provides a cylindrical phase distribution for selected beam widths along the target receiver direction, and compensates for a wavefront sphericity of the RF beam, defining a reflector array of unit cells, where the reflector array satisfies the total phase distribution, and disposing the reflector array onto a dielectric substrate.

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1A illustrates an example environment for passive reflectors according to one or more embodiments described and illustrated herein.

FIG. 1B illustrates another view of the environment of FIG. 1A according to one or more embodiments described and illustrated herein.

FIG. 2A illustrates an example passive reflector providing a plane phase distribution according to one or more embodiments described and illustrated herein.

FIG. 2B illustrates an example passive reflector providing a cylindrical phase distribution according to one or more embodiments described and illustrated herein.

FIG. 2C illustrates an example passive reflector compensating for wavefront sphericity according to one or more embodiments described and illustrated herein.

FIG. 3A illustrates an example phase distribution of a passive reflector providing no sphericity compensation and no azimuth beam spreading.

FIG. 3B illustrates an example phase distribution of a passive reflector providing for sphericity compensation but with no azimuth spreading.

FIG. 3C illustrates an example phase distribution of a passive reflector providing no sphericity compensation but with an added azimuth spreading of 20 degrees.

FIG. 3D illustrates an example phase distribution of a passive reflector providing sphericity compensation and azimuth spreading of 20 degrees according to one or more embodiments described and illustrated here.

FIG. 4A illustrates an example reflector array of a passive reflector according to one or more embodiments described and illustrated herein.

FIG. 4B illustrates an example unit cell according to one or more embodiments described and illustrated herein.

FIG. 5A illustrates another example environment for passive reflectors according one or more embodiments described and illustrated herein.

FIG. 5B illustrates a top-down view of the example environment of FIG. 5A according to one or more embodiments described and illustrated herein.

FIG. 6 illustrates an example method of fabricating a passive reflector according to one or more embodiments described and illustrated herein.

### DETAILED DESCRIPTION

References will now be made in detail to the embodiments of the disclosure, examples of which are illustrated in the accompanying drawings. Whenever possible, like reference numbers will be used to refer to like components or parts.

Embodiments of the present disclosure are directed to passive reflectors of radio-frequency (RF) beams for wireless communication systems. The passive reflectors described herein have a metamaterial surface in the form of arrays of unit cells that provide a phased distribution configured to reflect an incident RF beam propagating in free space toward a desired receiver at a desired direction in both azimuth and elevation, while simultaneously applying cylindrical phase distribution to ensure the reflected RF beam is not degraded by the ceiling, the floor, the walls or other objects, and also compensating for wavefront sphericity. In other words, the passive reflectors described herein provide steering in the given direction, cylindrical phase distribution and compensation of the wavefront sphericity in a single device. Prior art passive reflectors do not have a phased distribution that accomplish these three features simultaneously.

A primary goal of a passive reflector is the coverage improvement and/or system cost of ownership reduction by reduction of the number of remote nodes. In some cases, such as a hallway having a corner, a hallway may not be in the line of sight of a wireless transmitter, therefore requiring an additional wireless transmitter in that hallway. The passive reflectors described herein optimally reflect an RF beam from a transmitter in a line of sight hallway such around a corner into the non-line of sight hallway so that a portion of the non-line of sight hallway is covered by the transmitter, thereby reducing the number of transmitters needed. Thus, embodiments allow extending flexibility of choosing transmitter (also referred to as remote nodes (RNs)) locations, multi-beam system design and other considerations, which improve coverage and or capacity of 5G systems or decrease the cost of ownership of such systems.

Various embodiments of passive reflectors, wireless communication systems and methods of their fabrication are described in detail below.

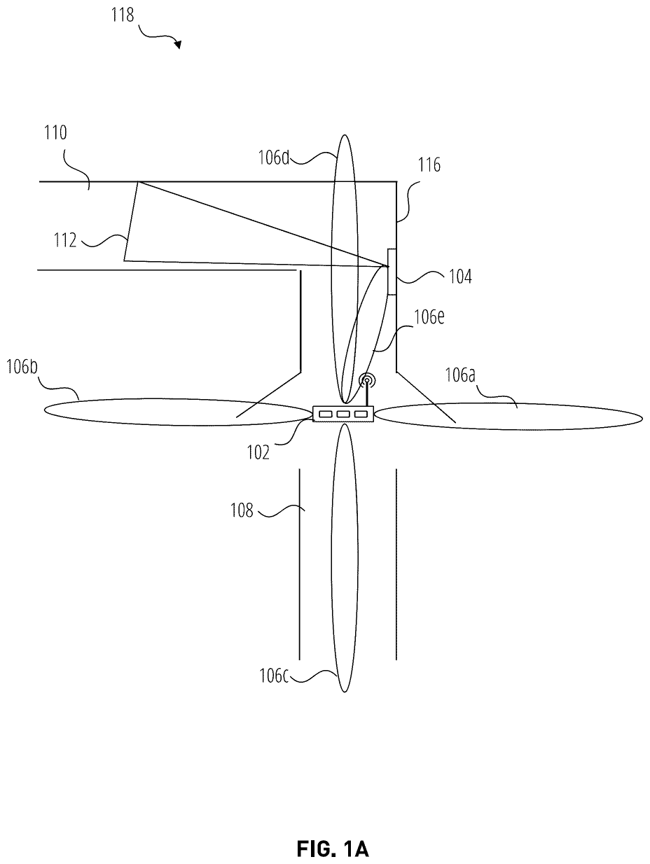

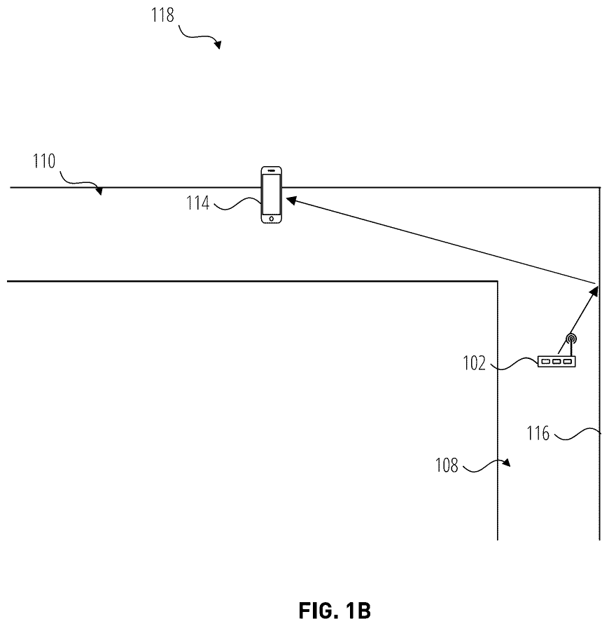

Referring now to FIG. 1A, an example environment 118 having a transmitter 102 is illustrated. FIG. 1B is a simplified illustration of the environment 118 of FIG. 1A. The example environment 118 includes a line of sight hallway 108 and a non-line of sight hallway 110 that intersects the line of sight hallway 108 around a corner (i.e., an L-shaped hallway). The transmitter 102 is positioned on the ceiling within the line of sight hallway 108 such that a first RF beam 106a and a second RF beam 106b propagate into adjacent rooms through doors. A third RF beam 106c and a fourth RF beam 106d propagate along the line of sight hallway 108. A fifth RF beam 106e propagates from the transmitter 102 at some azimuth angle.

The transmitter 102 may be, without limitation, a mmWave RN having two different polarizations, such as a TE polarization and a TM polarization. However, it should be understood that different transmitters may be utilized.

As shown in FIG. 1A, coverage within the non-line of sight hallway 110 is limited due to the corner.

The example environment 118 further includes a passive reflector 104 that is mounted on a wall 116 of the line of sight hallway 108. The fifth RF beam 106e is transmitted at an azimuth angle and an elevation angle such that it is incident on the surface of the passive reflector 104. The passive reflector 104 is configured to optimally reflect the fifth RF beam 106e as a reflected RF beam 112 that propagates into the non-line of sight hallway 110 such that the fifth RF beam 106e provides coverage for at least a portion of the non-line of sight hallway 110.

As described in more detail below, the meta-surface of the passive reflector 104 provides a total phase distribution that simultaneously provides for steering in the desired direction for an incident fifth RF beam 106e having a given azimuth angle and a given elevation angle, cylindrical phase distribution, and compensation of the wavefront sphericity. The passive reflector 104 and the operating environment 118 provide several design constraints. The reflected RF beam 112 should be directed into the non-line of sight hallway 110 and be wide enough along the azimuth to cover the whole width of the non-line of sight hallway 110. If the azimuth spread is not applied for target phase distribution of the surface of the passive reflector 104, a large surface area may make a very narrow reflected beam, i.e., strong signal coverage only within a very narrow zone. Further, the reflected RF beam 112 should not be so wide in the azimuth that most of the power is lost as wall reflections and transferred into undesirable directions resulting in undesirable propagation paths and interference. As a non-limiting example, 20 degrees azimuth may be appropriate for a 2.4 m hallway.

The reflected RF beam 112 should also be made narrow along the elevation to prevent power from being decimated at the floor and ceiling materials.

The transmitter 102 is not within sight of the non-line of sight hallway 110, and the passive reflector 104 should face the non-line of sight hallway 110 to reflect the reflected RF beam 112 into the non-line of sight hallway 110. Thus, a large incident angle of the signal (i.e., the fifth RF beam 106e) on the passive reflector 104 is helpful to allow a short distance between the transmitter 102 and the passive reflector 104 to collect more of the beam width. Too large of an angle of incidence may result in complexities of the passive reflector design due to edge effects. As a non-limiting example, the distance between the transmitter 102 and the passive reflector 104 may be in a range of 0.5 and 3 m, including endpoints.

The passive reflector 104 should also support both polarizations independently for polarization multiplexing. This implies the capability of controlling phase distribution for elevation/vertical ( ) and azimuth/horizontal ( ) components of the incident electric field vector of the incident RF beam.

As described in more detail below, for a large passive reflector 104 at a short distance from the transmitter 102, the wavefront of the incident fifth RF beam 106e will have a sphericity that should be compensated at the passive reflector 104. As the reflected RF beam 112 does not need to be focused at the target receiver 114, the sphericity of the reflected RF beam 112 may not be of concern.

Further, the surface of the passive reflector 104 should be as close as possible to the transmitter 102 to collect a larger angular section of the incident RF beam (e.g., the fifth RF beam 106e). At the same time, the transmitter 102 should be not within the line of sight relative to the non-line of sight hallway 110. Thus, the location of the passive reflector 104 should be just opposite an inner corner between the two hallways and the reflected RF beam 112 starts at zero degrees and covers 20 degrees azimuth.

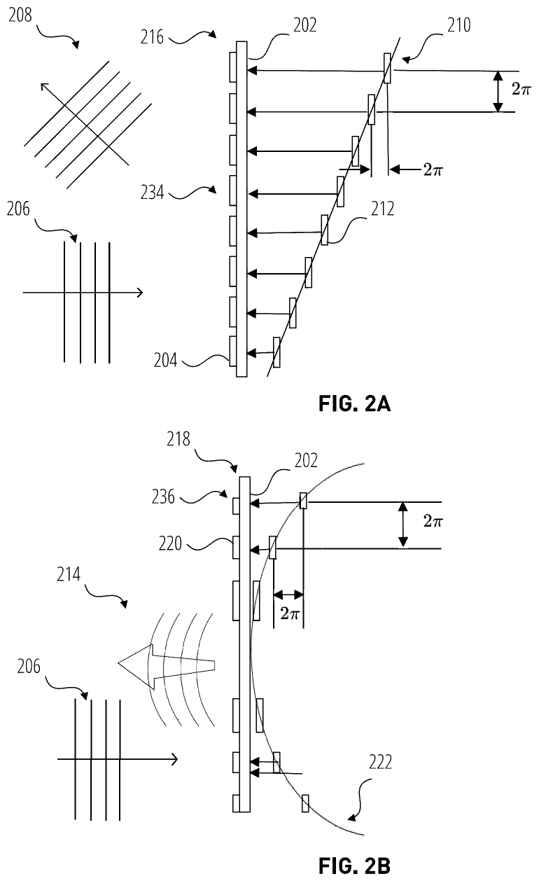

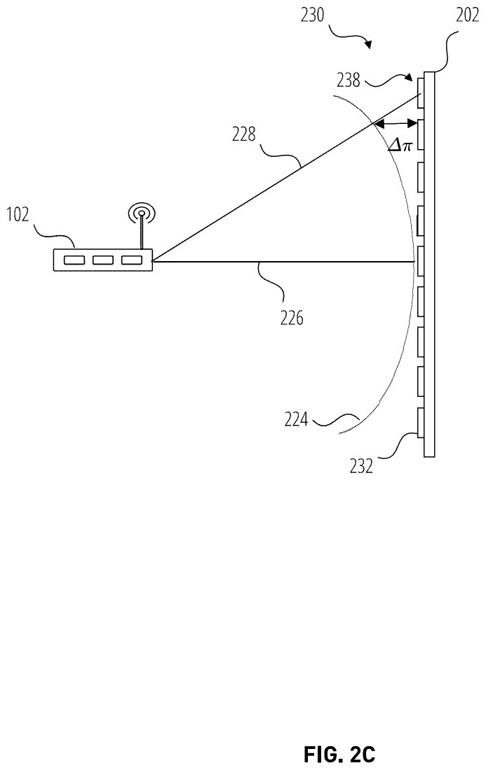

Referring now to FIG. 2A, an example plane reflector 216 having a reflector array 234 providing a plane phase 210 to redirect an incident wave 206 (i.e., an incident RF beam) is illustrated. The plane reflector 216 has an array of super cells 204 on a dielectric substrate 202 where each super cell 204 corresponds to a 2π phase retardation at the surface of the plane reflector 216 to redirect the incident wave 206 into an anomalous direction. As shown in FIG. 2A, effective super cells 212 are provided along the plane phase 210 to redirect the incident wave 206 as shown by the reflected wave 208.

As stated above, the reflected RF beam 112 should be widened to provide greater coverage area at the receiver 114. FIG. 2B illustrates an example cylindrical reflector 218 having a reflector array 236 providing a cylindrical phase 222. The cylindrical reflector 218 has an array of super cells 220 on a dielectric substrate 202 where each super cell 220 corresponds to a 2π phase retardation at the surface of the reflected wave 214, which modifies the width of the reflected wave 214.

Particularly for instances where the transmitter is located in close proximity to the passive reflector (e.g., less than 3 m), the wavefront of the incident wave will have a spherical shape. FIG. 2C illustrates a spherical wavefront 224 that is incident on a reflector 230 comprising a reflector array 238 having an array of super cells 232. Due to the spherical wavefront 224, a path length 226 from the transmitter 102 to a central region of the reflector 230 is shorter than a path length 228 from the transmitter 102 to a corner region of the reflector 230 by a difference factor Embodiments of the present disclosure compensate for the spherical wavefront 224 as described in more detail below.

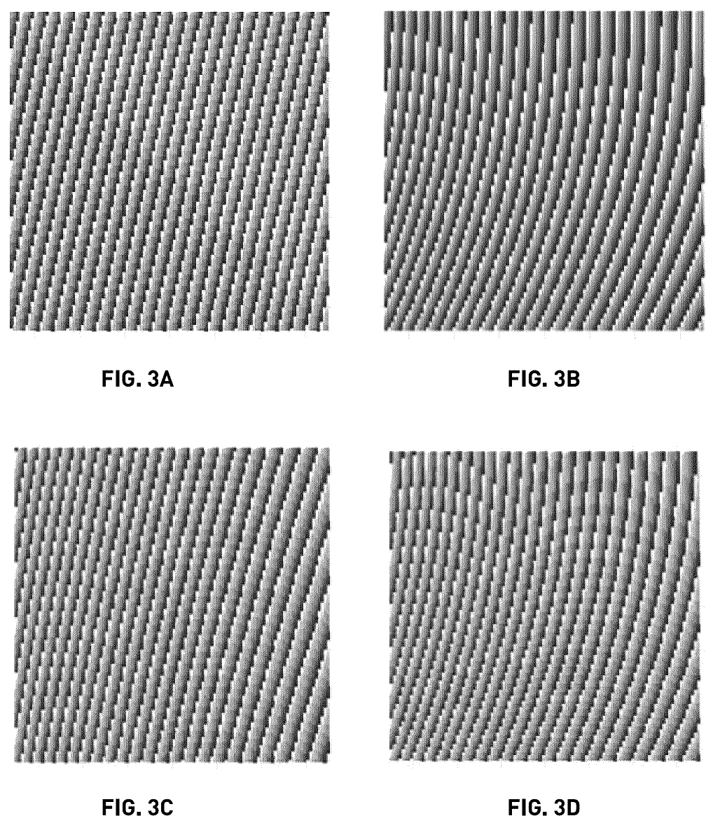

The passive reflectors described herein have a reflector array that combine the functionalities of the reflector arrays 234, 236 and 238 of FIGS. 2A-2C such that they provide steering in the given direction, cylindrical phase distribution, and compensation of the wavefront sphericity in a single device for two different polarizations. First, phase shift weights w_{c} for the unit cells of the passive reflector to achieve a total phase distribution that accomplishes the three functions described above and illustrated in FIGS. 2A-3C are determined. Next, the geometries of individual unit cells that provide for the phase shift weights we for the unit cells are determined. Finally, the reflector array having the unit cells geometries are provided on a dielectric substrate.

Determination of the phase shift weights we for a reflector array of a passive reflector is now described.

The scattering angle-dependent gain of the passive reflector, given wavefront incidence angle pair A and observation angle D is proportional to the following factor:

$${G}_{A , D} = {\vert {\sum }_{c = 1}^{{N}_{c}} {ψ}_{A , c} \cdot {w}_{c} \cdot {ψ}_{D , c} \vert}^{2} ,$$

where is the phase factor, which includes phase offset of the transmitter-passive reflector path A at unit cell location c., analogously, is a phase-factor with phase offset of the passive reflector-receiver path D at the unit cell location c. is the total number of unit cells in the reflector array of the passive reflector. The exact distances and from the transmitter or the receiver to the corresponding unit cell center location c in the expressions of
and allow the ability to account for potential sphericity of the wavefronts from the transmitter to the passive reflector or from passive reflector to the receiver:
where λ is the wavelength of radio signal, and the phase shift weight we represents the local phase response of the unit cell to the incident plane wave. The phase response is different for each unique geometry of the unit cell.

The phase shift weight we has two factors:

$${w}_{c} = {w}_{steering} \cdot {w}_{cylinder} .$$

For anomalous reflection (i.e., redirection), the W steering factor compensates for the phase differences of the strongest transmitter-passive reflector and passive reflector-receiver pairs for some target receiver direction:
where argmin (L_{TS}) is a path index (with minimum propagation losses) between the transmitter and a surface of the passive reflector, and argmin (L_{TS}) is a path index (with minimum propagation losses) between the surface of the passive reflector and the receiver. “conj” represents the complex conjugate operation. Because the path distances from the transmitter to the central point of the passive reflector and to the corner point of the passive reflector are different, conjugation will also introduce spherical phase distribution over the surface of the passive reflector, which compensates for the wavefront sphericity of the incident wave.

The w_{cylinder} factor specifies the scattered beam width of the reflected RF beam:
where y_{c} is a y-axis location of an individual unit cell, z_{c} is a z-axis location of an individual unit cell, and λ is a wavelength of the RF beam. For azimuth and elevation spreads of scattered beams, individual cylindrical phase shift factors are applied, according to dependence on y- and z-axis cell locations. For specifying the beam width in azimuth direction, a parameter is applied together with the size of the surface of the passive reflector, to get an imaginary cylinder radius of curvature. Analogously, is used to specify radius of curvature of the cylinder along vertical direction:
where y_{c, max}−y_{c, min} is a length of the passive reflector along the y-axis, z_{c, max}−z_{c, min} is a length of the passive reflector along the z-axis, Δ is a desired azimuth beam width, and is a desired elevation beam width.

Having obtained the w_{steering} factor and the w_{cylinder} factor, the phase shift weights w_{c} for the unit cells of the passive reflector can be determined.

FIGS. 3A-3D show phase distributions for different passive reflectors having a size of 35×35 cm² with an incident RF beam at −64 degrees azimuth and 14 degrees elevation to a receiver at 11 degrees azimuth and −2.5 degrees elevation, all relative to the surface normal. The white to black regions show a local phase response from −360 degrees to 0 degrees. FIG. 3A shows a phase distribution of a reflector providing no sphericity compensation and no azimuth beam spreading. FIG. 3B shows a phase distribution of a reflector providing for sphericity compensation but with no azimuth spreading. FIG. 3C shows a phase distribution of a reflector providing no sphericity compensation but with an added azimuth spreading of 20 degrees. Finally FIG. 3D shows a phase distribution of a reflector providing sphericity compensation and azimuth spreading of 20 degrees.

The phase shift weights we that are obtained can next be translated into geometrical and material configurations of the unit cells.

The dependence of the reflection phase on the configuration of the unit cells can be obtained from electromagnetic simulations with periodic boundary conditions for specified angle pair of incidence and polarization of the incident wave. Unique structures, such as, without limitation, thickness and permittivity of the dielectric substrate, height and geometry of the unit cell elements, result in unique phase shift weights we. The unit cell design can be very different depending on the requirements of the incidence angle, the range of phase shifts to support the desired signal bandwidth, dual polarization operation capability and the isolation of different polarization components, capabilities of manufacturing specified sizes of the unit cells and overall surface. Thus, embodiments of the present disclosure are not limited to any particular unit cell configuration. The gradient of the phase shift at each unit cell location also plays a role due to mutual coupling.

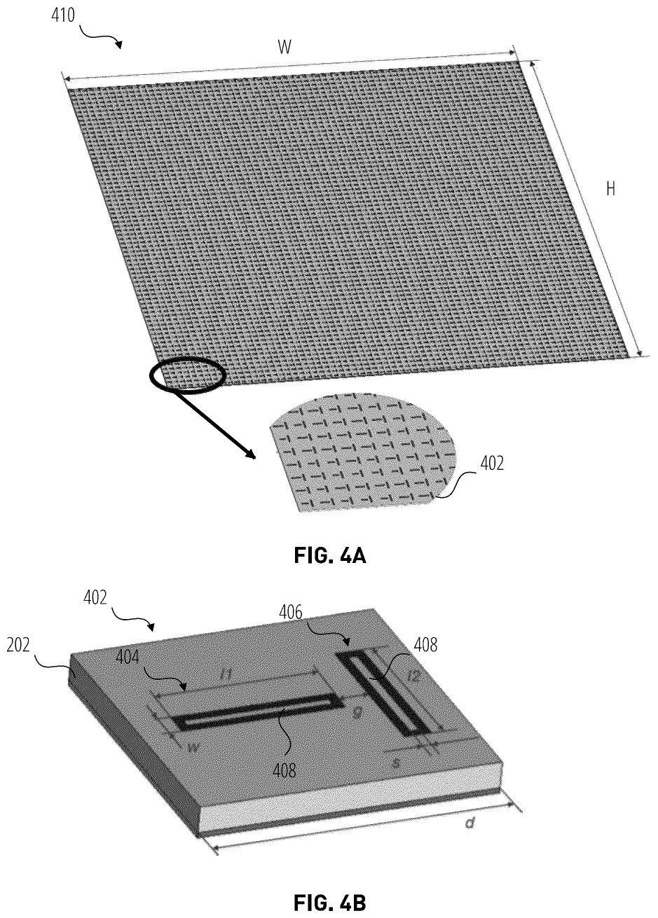

Referring now to FIG. 4A, a reflector array 410 of unit cells 402 is illustrated. As a non-limiting example, the reflector array 410 may have seventy unit cells 402 across a width W and seventy unit cells across a height H. However, it should be understood that the reflector array 410 may have other configurations, such as, without limitation, in a range of 70 by 70 unit cells to 240 by 240 unit cells.

FIG. 4B illustrates an example unit cell 402 in isolation. The unit cell 402 is a square having a step d. The unit cell comprises a dielectric substrate 202 and first conductive loop 404 and a second conductive loop 406 disposed on a surface of the dielectric substrate 202. The dielectric substrate 202 may be low-loss glass, for example. The dielectric substrate 202 may have a thickness within a range of 0.25 mm and 0.75 mm, including endpoints, for example. The first conductive loop 404 and the second conductive loop 406 may be provided on the dielectric substrate 202 by any means such as, without limitation, chemical etching or deposition processes. The first conductive loop 404 and the second conductive loop 406 may be made of any electrically conductive material, such as, without limitation, copper.

As a non-limiting example, for an RF beam having a frequency of 28 GHz, the first conductive loop length 11 and the second conductive loop length 12 may be in the in the range of 1.6 and 2.8 mm, including endpoints. The first conductive loop 404 and the second conductive loop 406 each include a slot 408 having a slot width s in a range of 0.125 mm and 0.175 mm, including endpoints. The first conductive loop 404 and the second conductive loop 406 further have loop widths w within a range of 0.4 mm and 0.5 mm, including endpoints. A distance between first conductive loop 404 and the second conductive loop 406 in the unit cell 402 g is within a range of 0.4 mm and 0.6 mm, including endpoints. The reflector array may have a unit cell period (i.e., step d) within a range of 4 mm and 6 mm, including endpoints. The first conductive loop 404 and the second conductive loop 406 are arranged orthogonal to one another to provide phased distribution for TE and TM polarizations.

It should be understood that the reflector array 410 and unit cells 402 illustrated in FIGS. 4A and 4B, as well as the dimensional values described above are for illustrative purposes only, and that the unit cells 402 will take on different shapes and/or dimensions depending on the application and the phase shift weight we that is desired.

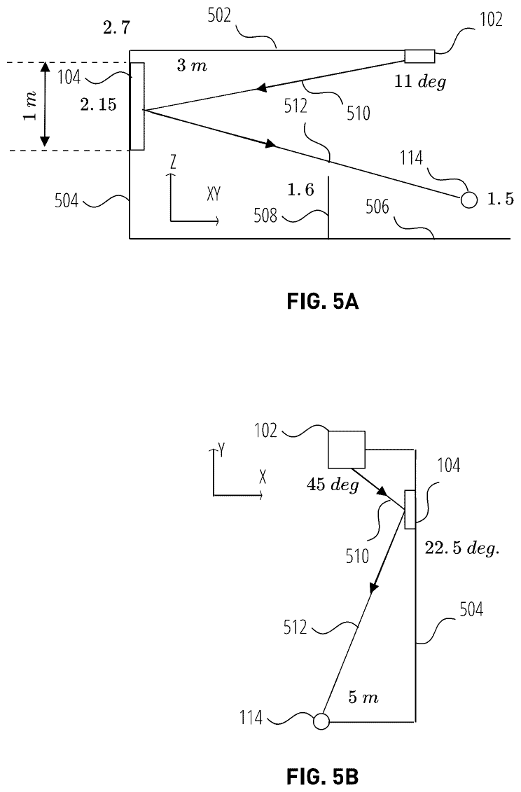

The passive reflectors described herein are not limited to L-shaped hallways, and may be installed in any environmental configuration. FIGS. 5A and 5B illustrate an office environment wherein a transmitter 102 is mounted on a ceiling 502. A passive reflector 104 is mounted on a wall 504 to receive an incident RF beam propagating along a transmitter-passive reflector path 510 to provide enhanced coverage in the office environment 118. The design parameters for the example of FIGS. 5A and 5B are as follows.

The distance between the passive reflector 104 and the target receiver 114 is 5 m, as shown by FIG. 5B, which is a quarter of the 20 m room width. Additional passive reflectors may be mounted on opposite walls and vary azimuth spread of the beam relative to this point. The incident wavefront of the incident RF beam is 45 degrees azimuth and 11 degrees elevations within a maximum directivity range. It should be understood that the transmitter 102 may be capable of propagating an RF beam at any range of azimuth or elevation angle. The reflected RF beam along passive reflector-receiver path 512 is 22.5 degrees azimuth, uncovered direction in-between existing beams of the transmitter, swept with step of 45 degrees. There is a 2-3 m transmitter 102 to passive reflector 104 distance in the XY plane to minimize existing coverage loss of the transmitter on one hand and to maximize the energy collected at the surface plane on the other hand. The passive reflector 104 of this non-limiting example has a width of 1 m to almost fully fit with a gap between a cubical wall having a height of 1.6 m and a 2.7 m ceiling, at a 2.15 height. The passive reflector 104 is designed as described above, and provide steering in the given direction, cylindrical phase distribution and compensation of the wavefront sphericity.

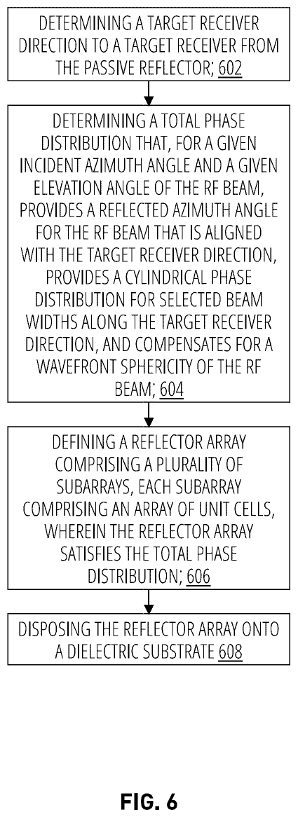

FIG. 6 illustrates an example method of designing a passive reflector capable of simultaneously providing steering in a given direction, providing cylindrical phase distribution and compensating for wavefront sphericity. Although the example method depicts a particular sequence of operations, the sequence may be altered without departing from the scope of the present disclosure. For example, some of the operations depicted may be performed in parallel or in a different sequence that does not materially affect the function of the routine. In other examples, different components of an example device or system that implements the routine may perform functions at substantially the same time or in a specific sequence.

According to some embodiments, the method includes determining a target receiver direction to a target receiver from the passive reflector at block 602. The target receiver is located at an azimuth angle and elevation angle from the location of a passive reflector. The method further includes determining a total phase distribution that, for the given incident azimuth angle and the given elevation angle of a RF beam produced by a transmitter, provides a reflected azimuth angle for the RF beam that is aligned with the target receiver direction, provides a cylindrical phase distribution for selected beam widths along the target receiver direction, and compensates for a wavefront sphericity of the RF beam at block 604.

Next, the method includes defining a reflector array comprising an array of unit cells and the reflector array satisfies the total phase distribution at block 606. The passive reflector is fabricated by disposing the reflector array onto a dielectric substrate at block 608.

It should now be understood that embodiments of the present disclosure provide passive reflectors for enhancing RF beam coverage over an environment, such as an L-shaped hallway, an office, or a home, for example. The disclosed passive reflectors simultaneously provide phase correction at the wavefront of an incident RF beam to provide steering in a given direction, cylindrical phase distribution to control the width of the reflected RF beam, and compensate for wavefront sphericity due to the close proximity of the transmitter to the passive reflector. In one example, the unit cell of a passive reflector is configured as two orthogonally positions conductive loops on a dielectric substrate that provide phase correction independently for two orthogonal polarizations of the incident RF beam (e.g., TE and TM polarization).

It is noted that recitations herein of a component of the embodiments being “configured” in a particular way, “configured” to embody a particular property, or function in a particular manner, are structural recitations as opposed to recitations of intended use. More specifically, the references herein to the manner in which a component is “configured” denotes an existing physical condition of the component and, as such, is to be taken as a definite recitation of the structural characteristics of the component.

It is noted that one or more of the following claims utilize the term “wherein” as a transitional phrase. For the purposes of defining the embodiments of the present disclosure, it is noted that this term is introduced in the claims as an open-ended transitional phrase that is used to introduce a recitation of a series of characteristics of the structure and should be interpreted in like manner as the more commonly used open-ended preamble term “comprising.”

Although the disclosure has been illustrated and described herein with reference to explanatory embodiments and specific examples thereof, it will be readily apparent to those of ordinary skill in the art that other embodiments and examples can perform similar functions and/or achieve like results. All such equivalent embodiments and examples are within the spirit and scope of the disclosure and are intended to be covered by the appended claims. It will also be apparent to those skilled in the art that various modifications and variations can be made to the concepts disclosed without departing from the spirit and scope of the same. Thus, it is intended that the present application cover the modifications and variations provided they come within the scope of the appended claims and their equivalents.

What is claimed is:

1. A passive reflector for reflecting a RF beam, the passive reflector comprising:
a dielectric substrate; and
a reflector array comprising an array of unit cells, wherein:
the reflector array is provided on a surface of the dielectric substrate;
each unit cell comprises a first conductive loop and a second conductive loop that is orthogonal to the first conductive loop; and
each unit cell provides a phase response for two different polarizations.

2. The passive reflector of claim 1, wherein the array of unit cells is such that each unit cell provides a phase shift weight we for the RF beam that is incident on the passive reflector.

3. The passive reflector of claim 1, wherein the first conductive loop and the second conductive loop are rectangular loops.

4. The passive reflector of claim 1, wherein the reflector array comprises an array of seventy by seventy unit cells.

5. The passive reflector of claim 1, wherein:
the first conductive loop and the second conductive loop have lengths within a range of 1.6 mm to 2.8 mm, including endpoints, loop widths within a range of 0.4 mm and 0.5 mm, including endpoints, and slot widths within a range of 0.125 mm and 0.175 mm, including endpoints;
the dielectric substrate has a thickness within a range of 0.25 mm and 0.75 mm, including endpoints;
a distance between the first conductive loop and the second conductive loop is within a range of 0.4 mm and 0.6 mm, including endpoints; and
the array of unit cells has a unit cell period that is within a range of 4 mm and 6 mm, including endpoints.

6. The passive reflector of claim 1, wherein the two different polarizations include a TE polarization and a TM polarization.

7. The passive reflector of claim 1, wherein the reflector array is configured to receive the RF beam from a transmitter located at a distance from the passive reflector within a range of 0.5 m and 3 m, including endpoints.

8. The passive reflector of claim 1, wherein the dielectric substrate is glass.

9. A passive reflector for reflecting a RF beam, the passive reflector comprising:
a dielectric substrate; and
a reflector array comprising an array of unit cells, wherein:
the reflector array is provided on a surface of the dielectric substrate; and
the array of unit cells is such that the passive reflector has a total phase distribution that, for a given incident azimuth angle and a given incident elevation angle of the RF beam, provides a reflected azimuth angle and a reflected elevation angle for the RF beam that is different from one or more of the given incident azimuth angle and the given incident elevation angle, provides a cylindrical phase distribution, and compensates for a wavefront sphericity of the RF beam.

10. The passive reflector of claim 9, wherein the reflector array comprises an array of seventy by seventy unit cells.

11. The passive reflector of claim 9, wherein each unit cell provides a phase response for two different polarizations.

12. The passive reflector of claim 11, wherein the two different polarizations include a TE polarization and a TM polarization.

13. The passive reflector of claim 9, wherein the reflector array is configured to receive the RF beam from a transmitter located at a distance from the passive reflector within a range of 0.5 m and 3 m, including endpoints.

14. The passive reflector of claim 9, wherein each unit cell comprises a first conductive loop and a second conductive loop that is orthogonal to the first conductive loop.

15. The passive reflector of claim 14, wherein:
the first conductive loop and the second conductive loop have lengths within a range of 1.6 mm to 2.8 mm, including endpoints, loop widths within a range of 0.4 mm and 0.5 mm, including endpoints, and slot width within a range of 0.125 mm and 0.175 mm, including endpoints;
the dielectric substrate has a thickness within a range of 0.25 mm and 0.75 mm, including endpoints;
a distance d between the first conductive loop and the second conductive loop is within a range of 0.4 mm and 0.6 mm, including endpoints;
a unit cell period of the array of unit cells is within a range of 4 mm and 6 mm, including endpoints; and
the RF beam has a frequency of 28 GHz.

16. The passive reflector of claim 9, wherein the array of unit cells is such that each unit cell provides a phase shift weight we for the RF beam that is incident on the passive reflector.

17. The passive reflector of claim 16, wherein the phase shift weight we as has a steering component w_{steering} and a cylinder component w_{cylinder}.

18. A wireless communication system comprising:
a transmitter configured to emit a RF beam at an azimuth and elevation angle;
a passive reflector for receiving the RF beam at the azimuth and elevation angle, the passive reflector comprising:
a dielectric substrate; and
a reflector array comprising an array of unit cells, wherein:
the reflector array is provided on a surface of the dielectric substrate; and
the array of unit cells is such that the passive reflector has a total phase distribution that, for a given incident azimuth angle and a given incident elevation angle of the RF beam, provides a reflected azimuth angle and a reflected elevation angle for the RF beam that is different from one or more of the given incident azimuth angle and the given incident elevation angle, provides a cylindrical phase distribution, and compensates for a wavefront sphericity of the RF beam.

19. The wireless communication system of claim 18, wherein the reflector array comprises an array of seventy by seventy unit cells.

20. The wireless communication system of claim 18, wherein each unit cell provides a phase response.
